(19) United States
(12) Patent Application Publication
(10) Pub. No.: US 2020/0031075 A1
(43) Pub. Date: Jan. 30, 2020

(54) SLIDING SURFACE FOR A CONTINUOUSLY OPERATING DOUBLE-BELT PRESS AND DOUBLE-BELT PRESS

(71) Applicant: Held Technologie GmbH, Trossingen-Schura (DE)

(72) Inventors: Gerhard Blickle, Trossingen (DE); Richard Fisel, Trossingen-Schura (DE); Jörg Gosda, Trossingen (DE); Salvador Pfeffer, Balingen-Endingen (DE)

(21) Appl. No.: 16/512,545

(22) Filed: Jul. 16, 2019

(30) Foreign Application Priority Data
Jul. 27, 2018 (DE) 10 2018 118 212.0

(51) Int. Cl. B30B 5/06; B32B 37/10; B29C 43/48

(52) U.S. Cl. CPC B30B 5/06; B29C 2043/483; B29C 43/48; B32B 37/1027

(57) ABSTRACT

The invention pertains to a sliding surface for a continuously operating double-belt press for manufacturing endless material strips such as laminates, particularly copper laminate, decorative laminate, fiber-reinforced plastic laminates and/or other technical laminates, wherein the double-belt press comprises an upper and a lower endless press belt (04) that are guided over deflection rollers, wherein a reaction zone (13), in which the material strip is guided and pressed together under a surface pressure, is formed between the opposing outer sides of the press belts, wherein the double-belt press furthermore has a pressure chamber (08) that generates at least part of the surface pressure and is formed in the reaction zone (13) between a base element (07), particularly a heating plate, and an inner side (11) of the press belt (04), wherein said pressure chamber can be acted upon with a fluidic pressure medium and is laterally bounded and sealed by the at least one annular, closed sliding surface (01), wherein the sliding surface (01) has a sealing surface (12) for abutting on the inner side (11) of the press belt (04) in a sealing manner, wherein the sliding surface (01) comprises a sealing element (02) that forms the sealing surface (12) and a sealing frame (03) that at least partially accommodates the sealing element (02) and serves for movably supporting the sliding surface (01) in the base element (07), particularly in the heating plate, wherein a compression element (17) is arranged between the sealing frame (03) and the sealing element (02) at least in a pressing direction, and wherein said compression element allows a motion of the sealing element (02) relative to the sealing frame (03) due to an elastic compression, especially in reaction to a pressure application on the sliding surface (01) in the pressing direction.

### BACKGROUND OF THE INVENTION

The invention pertains to a sliding surface for a continuously operating double-belt press for manufacturing endless material strips such as laminates, particularly copper laminate, decorative laminate, fiber-reinforced plastic laminates and/or other technical laminates, wherein the double-belt press comprises an upper and a lower endless press belt that are guided over deflection rollers, wherein a reaction zone, in which the material strip is guided and pressed together under a surface pressure, is formed between the opposing outer sides of the press belts, wherein the double-belt press furthermore has a pressure chamber that generates at least part of the surface pressure and is formed in the reaction zone between a base element, particularly a heating plate, and an inner side of the press belt, wherein said pressure chamber can be pressurised with a fluidic pressure medium and is laterally bounded and sealed by the at least one annular, closed sliding surface, wherein the sliding surface has a sealing surface for abutting on the inner side of the press belt in a sealing manner, and wherein the sliding surface comprises a sealing element that forms the sealing surface and a sealing frame that at least partially accommodates the sealing element and serves for movably supporting the sliding surface in the base element, particularly in the heating plate.

The present invention furthermore pertains to a continuously operating double-belt press as disclosed herein.

Continuously operating double-belt presses for pressing together substrates or materials strips and the use of sliding surface for sealing a pressure chamber between the press belts of the double-belt press and a base element, particularly a heating element, are sufficiently known and described, for example, in publications DE 41 28 024 A1 and DE 42 19 226 C2. Referred to the direction of rotation or revolution of the press belts, the closed sliding surface form sections that extend along the direction of revolution or rotation, as well as regions that extend transverse to the direction of rotation or revolution of the press belts, particularly in the entry and exit regions of the press or the press belts.

Different problems arise in connection with these sliding surface in the prior art. In the entry and exit regions of the press, the transversely extending sections of the sliding surface can, if applicable, exert locally different pressures upon the rear side of the press belt or upon the inner side of the press belt due to the rigidity of the seal and due to manufacturing and installation tolerances and thereby lead to adverse effects, which particularly manifest themselves in the form of visible longitudinal streaks on the finished product or the manufactured material strip, particularly when processing sensitive materials.

Another disadvantage of known sliding surface and known continuously operating double-belt presses can be seen in that the known double-belt presses and the known sliding surface thus far only made it possible to process and/or press together undersized material strips if the undersized material was realized very thin, for example with a thickness of only a few tenths of a millimeter. A person skilled in the art refers to an undersize if the width of the material strips to be pressed together turns out smaller than the distance between the longitudinally extending sections of the sliding surface of the double-belt press. Until now, the manufacture of undersized material strips also was hardly possible or highly problematic because the transversely extending sections of the sliding surface were unable to follow the progression, particularly the S-shaped progression, of the press belts around the lateral edges of the material strips or materials to be pressed together, particularly in the entry and exit regions of the press, due to the rigidity of the sliding surface and an impermissibly high leakage of fluidic pressure medium from the pressure chamber occurred as a result thereof. However, the demand for double-belt presses, particularly continuously operating double-belt presses, that also make it possible to process or manufacture undersized pressed materials or material strips is particularly high because a correspondingly dimensioned double-belt press, in which the distances of the sliding surface seal are in the longitudinal sections adapted to the width of the material strips or materials to be pressed, otherwise has to be procured and operated for a correspondingly smaller size, particularly for a correspondingly smaller width of the material strips or materials to be pressed together. In addition, the basic operation of double-belt presses with oversized materials to be pressed together, i.e. with a lateral projection of the material strips or materials to be pressed together over the width of the sliding surface in the longitudinal sections, leads to a large amount of waste, wherein the oversize in fact prevents the leakage of fluidic pressure medium from the pressure chamber because the sliding surface does not have to adapt itself to a corresponding contour, particularly in the entry and exit regions, but the material strips or materials to be pressed together, which are guided through the double-belt press beyond or outside the sliding surface, are not pressed together with a sufficient surface pressure and not acted upon with the desired or required temperature profile and therefore inevitably form corresponding waste that has to be separated from the manufactured material strips and discarded.

### SUMMARY OF THE INVENTION

Based on this prior art, the present invention aims to propose sliding surface for continuously operating double-belt presses, as well as corresponding double-belt presses, which allow a more flexible use with respect to the width of the material strips or materials to be pressed together and at the same time make it possible to achieve an improved work result, particularly material strips of higher quality.

With respect to a sliding surface for a continuously operating double-belt press, this objective is attained with the characteristics disclosed herein, i.e. in that a compression element is in a generic sliding surface arranged between the sealing frame and the sealing element at least in a pressing direction, wherein said compression element allows a motion of the sealing element relative to the sealing frame due to an elastic compression, particularly an at least partially elastic compression, especially in reaction to a pressure application on the sliding surface in the pressing direction.

In this way, the local flexibility of the sliding surface is significantly increased in a particularly advantageous manner such that the sliding surface, particularly the sealing surfaces of the sliding surface, can be optimally adapted to the progression of the respective press belts, particularly in the entry and exit regions of the double-belt press, wherein a uniform pressure application on the inner side of the press belts can thereby be achieved and an excellent sealing effect is simultaneously produced, namely even if undersized materials are pressed together by the double-belt press.

The basic idea of the present invention is therefore based on the realization that a compression element arranged between the sealing element and the sealing frame allows a flexibilization, particularly a local flexibilization, of the sealing elements such that an altogether homogenous contact pressure can be exerted upon the inner side of the press belt in reaction to a pressure application on the sliding surface from the rear side or from the base element and the sliding surface also can better follow a progression of the inner side of a press belt due to a locally different compression of the compression element or a compression of the compression element with locally different intensity while still achieving a homogenous contact pressure, which particularly turns out to be so high that no disadvantageous or undesirable leakage of pressure medium from the pressure chamber can be observed.

In this way, the use of the inventive sliding surface also makes it possible to operate double-belt presses with undersized materials to be pressed together and to achieve a high-quality result.

According to a first advantageous embodiment of the sliding surface, the compression element may be realized in the form of a closed O-ring. Such a design of the compression element proved particularly advantageous with respect to the local flexibilization of the sealing element relative to the sealing frame, as well as with respect to a homogenous pressure application on the inner sides of the press belts. As an alternative to a closed O-ring, a round cord configured into a ring or an inserted, open sealing cord with circular cross section may also be used. The latter design is advantageous for taking into account or for compensating the thermal expansion of the compression element.

With respect to the arrangement of the compression element, it should on the one hand be ensured that the desired or intended flexibilization of the sealing element or the sealing surface of the sealing element is achieved, but the stability of the sliding surface, particularly also the stability of the support of the sealing element in the sealing frame, should at the same time not be unduly affected. These requirements are met in another particularly advantageous embodiment of the sliding surface, according to which the sealing frame comprises a groove for accommodating the sealing element, wherein the compression element is arranged along a groove base of the sealing frame. In this way, the compression element is largely fixed and stabilized in two of three directions in space. In such an arrangement, the compression element is accommodated and guided by the sealing frame on three of four peripheral sides and fixed or restricted with respect to its mobility by the sealing element on a fourth peripheral side.

In another advantageous embodiment, it is proposed that the sealing element is at least partially or sectionally made of a material with a low modulus of elasticity, particularly a polymer or a metal. In this respect, it is particularly sensible if the sealing element is made of the corresponding polymeric or metallic material in the entry and exit regions of the double-belt press. In these regions, a flexibilization according to the inventive idea, particularly the local or punctiform flexibilization of the sliding surface, especially the sealing elements, is of particular importance for pressing together undersized material strips, as well as for manufacturing high-quality pressed materials. Accordingly, the sealing element may be realized in such a way that the polymeric material is selectively used in the regions of the sealing element, which form the sections of the sealing element that extend transverse to the direction of rotation or revolution of the press belts. However, the aforementioned advantages can also be realized with a sealing element that is entirely made of a polymer with a low modulus of elasticity.

The realization of the inventive sliding surface, which comprise the compression element arranged between the sealing element and the sealing frame, is associated with a particular challenge with respect to securing or fastening the sealing element relative to the sealing frame. This particularly applies to the sections or regions of the sliding surface, which are arranged in the direction of revolution or rotation of the press belts. In other words, this means that the sealing elements are at a distance from the entry and exit regions of the press subjected to an enormous shearing force due to the motion of the press belts, particularly in light of the fact that the sealing surfaces of the sliding surface are pressed against the inner side of the press belt with a pressure up to 200 bar or 20 N/mm² depending on the intensity of the corresponding pressure, for example, in the pressure chamber. Since it can occur, for example, that the press belt and the sealing element run dry or that encrustations are formed between the press belt and the sealing element, there is a fundamental risk of the press belts carrying along or shifting the sealing elements in the direction of rotation or revolution of the press such that the sliding surface at least becomes leaky or is even damaged.

In order to solve these problems with respect to securing or fastening the sealing elements, another particularly preferred embodiment of the sliding surface proposes that the sealing element at least sectionally comprises blind holes or milled recesses on a lateral face bordering on the sealing surface, wherein the sealing frame comprises caulkings that at least partially engage into the blind holes and secure the sealing element relative to the sealing frame. The blind holes or milled recesses and the correspondingly provided caulkings of the sealing frame ensure that the shearing forces, which the press belt exerts upon the sealing surface and therefore upon the sealing element, can be reliably introduced into the substructure, particularly into the correspondingly massive and stable sealing frame, without the risk of damaging or shifting the sealing elements. Milled recesses preferably can be used in sealing elements of metal, particularly bronze. The caulkings may be realized, for example, in the form of punctiform caulkings, which are placed on an upper end of a lateral edge of the sealing frame in such a way that the sealing frame is in the region of the blind hole deformed in an at least punctiform manner and material of the sealing frame therefore at least partially protrudes into the blind hole of the sealing element in the caulked region.

In this context, a particularly advantageous embodiment proposes that the blind holes and the caulking are dimensioned relative to one another in such a way that the motion of the sealing element relative to the sealing frame can be realized up to a maximum stroke due to a compression of the compression element and the sealing element furthermore is secured relative to the sealing frame. Apart from the intended maximum stroke of the sealing element perpendicular to the sealing surface or in the pressing direction, the dimensioning of the blind hole and the caulking in the longitudinal direction, particularly in the circumferential direction of the sealing element, may be realized in such a way that no relative motion or only a minimal relative motion between the sealing element and the sealing frame is tolerated. It would accordingly be possible, for example, to realize the blind hole in the form of an oblong hole that extends on the lateral face along the pressing direction, wherein the width of the oblong hole particularly is chosen such that it is essentially filled or approximately filled with the material of the sealing frame, which is deformed in the course of the caulking process, whereas the length of the oblong hole particularly is chosen such that the corresponding maximum stroke of the sealing element in the pressing direction can be realized in reaction to a deformation of the compression element.

With respect to the inventive continuously operating double-belt press, the above-defined objective is attained with a double-belt press for manufacturing endless material strips such as laminates, particularly copper laminate, decorative laminate, fiber-reinforced plastic laminates and/or other technical laminates, wherein the double-belt press comprises a rigid press frame, deflection rollers that are rotatably supported on bearing brackets of the press frame and an upper and a lower endless press belt that are guided over the deflection rollers, wherein a reaction zone, in which the material strip is guided and pressed together under a surface pressure, is formed between the opposing outer sides of the press belts, wherein the double-belt press furthermore has a pressure chamber that generates at least part of the surface pressure and is formed in the reaction zone between a base element, particularly a heating plate, and an inner side of the press belt, wherein said pressure chamber can be acted upon with a fluidic pressure medium and is laterally bounded and particularly sealed by the at least one annular, closed sliding surface, wherein the sliding surface has a sealing surface for abutting on the inner side of the press belt in a sealing manner and is supported in the base element so as to be movable in a pressing direction, wherein the support comprises an at least partially elastic, movable pressing element that presses the sealing surface against the inner side of the press belt in the pressing direction due to a pressure application on the sliding surface on the side of the base element, and wherein the double-belt press is characterized in that the sliding surface is realized in accordance with one of the above-described embodiments, i.e. that the sliding surface comprises in addition to the sealing element and the sealing frame at least one compression element, which is arranged between the sealing element and the sealing frame in the pressing direction.

The above-described advantages with respect to pressing together undersized pressed materials, as well as the advantages with respect to the quality of the manufactured material strips, are achieved with the inventive double-belt press. With respect to advantageous embodiments and the associated preferred effects, we refer to the preceding description of the sliding surface.

According to an advantageous embodiment of the double-belt press, it is furthermore proposed that the double-belt press comprises at least two annular, closed sliding surface that at least sectionally extend parallel to one another and are realized in accordance with one of the above-described embodiments. This respectively makes it possible to additionally reduce the leakage and to withdraw pressure medium, which intentionally leaks from the pressure chamber into an intermediate space between the first sliding surface and the second sliding surface via the first sliding surface, by means of a vacuum in the intermediate space.

### BRIEF DESCRIPTION OF THE DRAWINGS

Advantageous embodiments of the invention are described below with reference to the schematic drawings.

In these drawings:

FIG. 1 shows a section along a sliding surface in the entry region of a double-belt press according to the prior art;

FIG. 2 shows a schematic representation of a detail of a section through a double-belt press according to the prior art in the region of the sliding surface;

FIG. 3 shows a schematic top view of an inner side of a double-belt press according to the prior art from the viewing direction of a base element;

FIG. 4 shows a schematic detail of a section through a double-belt press according to the present invention in the region of the sliding surface;

FIG. 5a shows a schematic representation of a detail of a side view of a sliding surface according to an embodiment of the present invention;

FIG. 5b shows a schematic section along the plane of section AA in FIG. 5a; and

FIG. 6 shows a section along a sliding surface in the entry region of a double-belt press according to the present invention.

In the figures, identical elements or elements with the same function are respectively identified by the same reference symbols.

### DETAILED DESCRIPTION

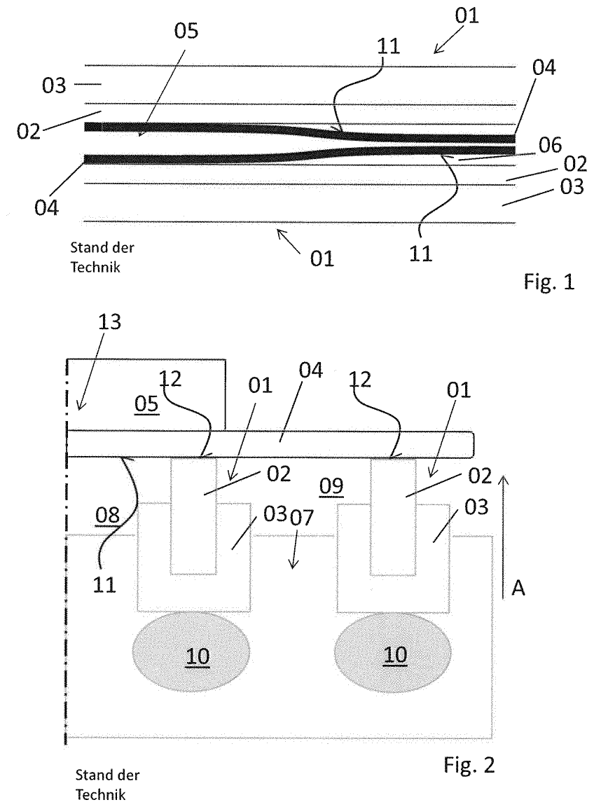

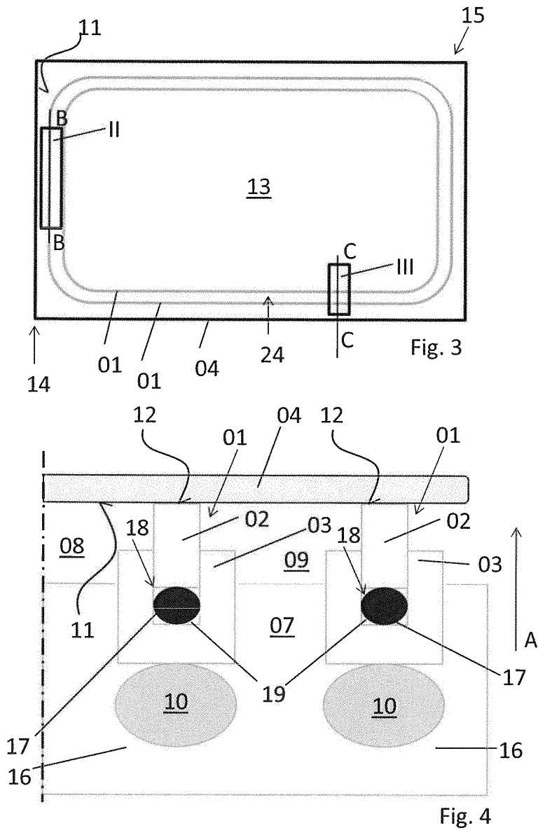

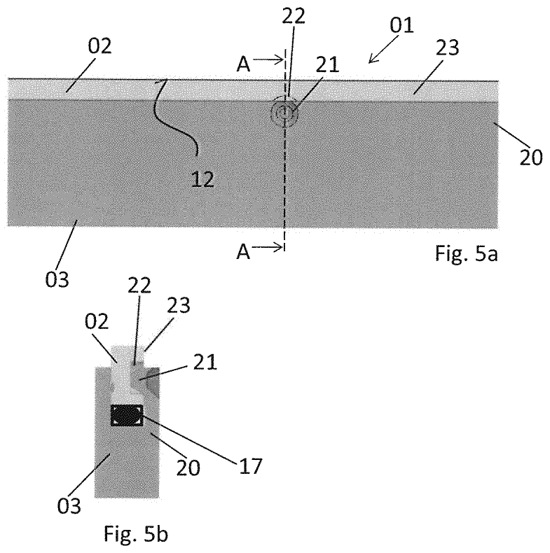

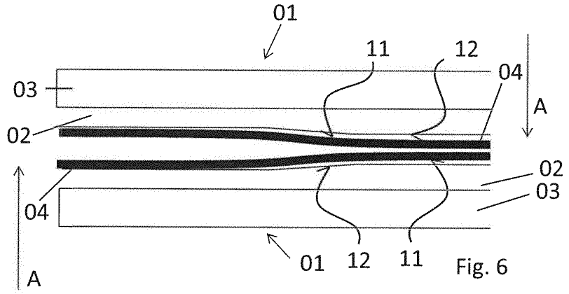

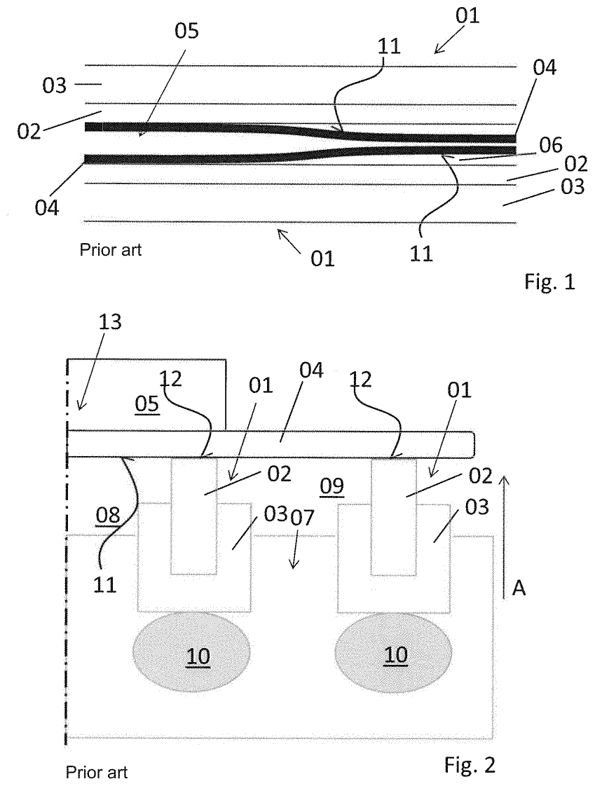

FIG. 1 shows an upper and a lower sliding surface 01 in the entry region of a double-belt press, which is not illustrated in FIG. 1. In this case, the sliding surface 01 comprises a sealing element 02 and a sealing frame 03, wherein the sealing frame 03 is conventionally accommodated by a base element, particularly a heating plate, and movably supported therein. The base element is also not illustrated in FIG. 1 in order to provide a better overview. A pressure chamber is formed between the sliding surface 01, the base element that is not illustrated in FIG. 1 and the press belts 04 of the double-belt press, wherein said pressure chamber is acted upon with a fluidic pressure medium, particularly for pressing the press belts 04 against the materials 05 to be pressed together.

In FIG. 1, the direction of rotation or revolution of the press belts 04 extends, for example, into the plane of projection in the section shown in FIG. 1 and correspondingly out of the plane of projection of FIG. 1 in a respective region extending above or underneath the section shown. In the exemplary illustration according to FIG. 1, the materials 05 to be pressed together have a width that is smaller than the width of the sliding surface in the entry region or the materials 05 to be pressed together have a width that is smaller than the distances of the sliding surface in the longitudinal direction of the double-belt press or in the direction of rotation of the press belts of the double-belt press. Due to the conventional or known sliding surface 01 with a lacking or insufficient flexibility between the sliding surface 01, particularly the sealing element 02, and the press belt 04 in the region, in which no materials 05 to be pressed together are provided or exist, the corresponding undersize of the materials 05 to be pressed together leads to the formation of a leakage gap 06, which is illustrated in FIG. 1 and in turn leads to an excessive and undesirable loss of pressure mediums from the pressure chamber. Consequently, a double-belt press and a sliding surface 01 according to the prior art illustrated in FIG. 1 only make it possible to process undersized materials 05 to be pressed together and to manufacture corresponding material strips if the thickness of the materials to be pressed together amounts to only a few tenths of a millimeter.

In addition, the known sliding surface 01, which are described in greater detail below with reference to FIG. 2, have the disadvantage that an uneven pressing effect or an uneven contact pressure is exerted upon the press belts 04, particularly in the entry region and in the exit region of the double-belt press, wherein this can lead to the formation of visible streaks in the manufactured material strips.

FIG. 2 shows a detail of a section through a double-belt press according to the prior art. In this case, the double-belt press comprises two sliding surface 01 that extend parallel to one another and likewise have a sealing element 02 and a sealing frame 03 for accommodating the sealing element 02. Different pressure chambers are formed between the press belt 04 and the base element 07 by the sliding surface 01. On the one hand, a pressure chamber 08 is formed within the first or inner sliding surface 01 and can be acted upon with a fluidic pressure medium. In known double-belt presses, the pressure chamber 08 preferably can be acted upon with a pressure up to 80 bar. A vacuum chamber 09 is formed between the first or inner sliding surface 01 and the second or outer sliding surface 01 and accordingly can be acted upon with a vacuum, for example, in order to withdraw or discharge pressure medium leaking from the pressure chamber. The sliding surface 01 are movably supported in the base element 07 in that the sealing frame 03 is movably guided in a recess of the base element 07. The sealing effect of the sealing elements 01 relative to the press belt 04 particularly is realized in that the sliding surface 01 are acted upon with a pressure on the side of the base element. In the example according to FIG. 2, it would be possible, for example, to exert a pressure upon the pressing elements 10, which are also movably supported in the base element 07 and may be realized, for example, in the form of elastic O-rings of FKM and/or FFKM material, on the side of the base element such that the pressure is transmitted to the sliding surface 01, particularly to the sealing frames 03 of the sliding surface 01, via the pressing elements 10 and the sealing elements 02 connected to the sealing frame 03 are in turn pressed against the inner side 11 of the press belt 04 by the transmitted pressure. The sealing element 02 accordingly forms a sealing surface 12 in the contact region with the inner side 11 of the press belt 04.

The reaction zone 13, which lies between the pressure chambers 08 and is bounded by the inner sliding surface 01, is formed between the press belts 04, particularly between the opposing outer sides of the press belts 04, wherein the material strips are manufactured of the materials 05 to be pressed together in said reaction zone. According to the schematic illustration in FIG. 2, the materials 05 to be pressed together have to be manufactured or processed with an oversize in order to prevent the formation of the leakage gap 06, which is illustrated in FIG. 1 and occurs if undersized materials to be pressed together are guided through the double-belt press. This means that the materials 05 to be pressed together must have a width that protrudes at least over the reaction zone and therefore at least over the inner sliding surface 01 in the sides or longitudinal regions of the double-belt press and the sliding surface 01.

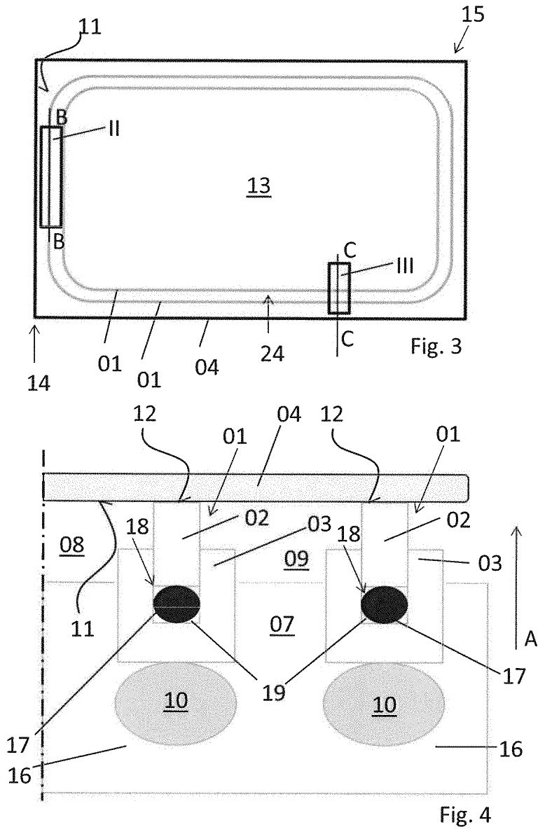

FIG. 3 shows a schematic top view of an inner side 11 of a press belt from the viewing direction of a heating plate or a base element 07, which is not illustrated in FIG. 3. For example, the illustration in FIG. 1 is extracted from the region II. along the plane of section BB. The illustration in FIG. 2 is extracted, for example, from the region III. along the plane of section CC. Accordingly, the entry region 14 into the double-belt press is located on the left side of the inner side 11 of the press belt 04 and the exit region 15 of the double-belt press is located in the right region. FIG. 3 likewise shows an inner sliding surface 01 and an outer sliding surface 01, which are respectively realized in an annular and closed manner, wherein at least the inner sliding surface 01 bounds and also largely seals the reaction zone 13 laterally, i.e. at a right angle to the plane of projection of FIG. 3.

FIG. 4 shows a detail of a section through an inventive double-belt press that comprises two inventive sliding surface 01. The illustration in FIG. 4 essentially corresponds to the illustration in FIG. 2. Identical elements of the sliding surface 01 and of the double-belt press are provided with and identified by the same reference symbols. Analogous to FIG. 2, the sliding surface 01 are movably supported in the base element 07 by means of a recess 16, wherein a pressure on the side of the base element is transmitted to the sliding surface 01, particularly to the sealing frames 03, via the pressing elements 10 such that the sealing surfaces 12 of the sealing elements 02 are ultimately pressed against the inner side 11 of the press belt 04.

In contrast to the realization of the sliding surface 01 in accordance with the prior art illustrated in FIG. 2, the sliding surface 01 according to the present invention comprise a compression element 17 that allows a motion of the sealing element 02 relative to the sealing frame 03, particularly in reaction to a pressure application on the sliding surface 01 in the pressing direction A, wherein the compression element 17 is subjected to or carries out an elastic compression in order to allow the relative motion between the sealing element 02 and the sealing frame 03. In this case, the compression element 17 is arranged in a groove 18 of the sealing frame 03. The compression element 17 particularly is arranged on the groove base 19 of the groove 18 of the sealing frame 03. Accordingly, the groove 18 with the groove base 19 serves for at least partially accommodating and guiding the sealing element 02 and at the same time for accommodating and guiding the compression element 17. The compression element 17 serves for realizing an essential aspect of the invention, namely that a pressure exerted upon the recess 16 in the base element on the side of the base element 07 is transmitted to the sealing element 02 and its sealing surface 12 by the compression element 17 via the pressing element 10 and the sealing frame 03 such that the pressure leads to a more or less intense compression of the compression element within the groove 18 of the sealing element 03 in dependence on the resistance of the press belt 04 and a pressing force of the sealing surface 12 is in fact exerted upon the inner side 11 of the press belt 04, but the sealing element 02 is at the same time realized such that it is movable relative to the sealing frame 03 at least over a certain stroke, which is defined by the compressibility and deformability of the compression element 17, wherein this altogether leads to a flexibilization, particularly a local flexibilization, of the sliding surface 01 such that a more uniform pressure can be exerted upon the inner side 11 of the press belt 04 via the sealing surface and a superior adaptability and pressure applicability to a local contour change of the press belt 04, particularly also an inner side 11 of the press belt, is ensured. The compression element 17 preferably is realized in the form of a closed O-ring that is made of a material, which can withstand the operating temperatures of the double-belt press, as well as the temperatures prevailing at the location of the sliding surface, and at the same time ensures the desired functionality as an elastic compression element.

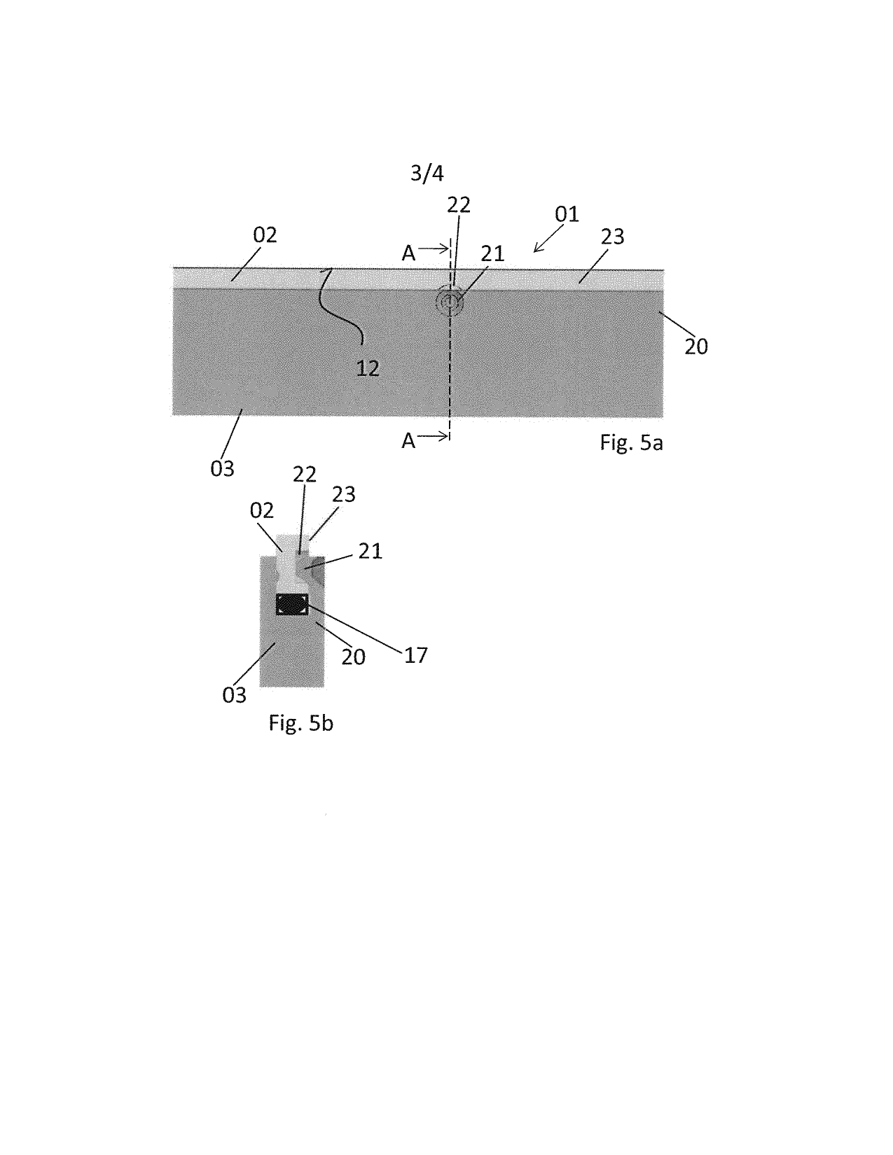

FIG. 5a shows a detail of a side view of an inventive sliding surface according to a preferred embodiment. This side view shows the sealing frame 03 and the sealing element 02, which is at least partially accommodated by the sealing frame 03. The sealing element 02 forms the sealing surface 12, which is arranged on top in the side view according to FIG. 5a. In FIG. 5a, a caulking is illustrated in the upper section of the sealing frame 03, wherein said caulking is realized, for example, in the form of a circular or punctiform caulking and arranged in the upper region of a sidewall 20 of the sealing frame 03 in such a way that the material displaced in the direction of the interior of the sealing frame 03 by the caulking 21 engages into a blind hole 22 and thereby secures and/or fastens the sealing element 02 relative to the sealing frame 03.

According to FIG. 5a, the blind hole 22, which is likewise arranged in a lateral face 23 of the sealing element 02, is dimensioned larger than the material or deformation section that protrudes into the interior of the groove 18 of the sealing frame 03 during the course of the caulking process. This dimensioning of the blind hole 22 relative to the caulking 21 serves for preventing that the caulking of the sealing frame 03 relative to the sealing element 02 does not cancel or unduly restrict the motion of the sealing frame relative to the sealing element 02, which is particularly realized by means of the inventive compression element 17. Accordingly, the caulking 21 and the blind hole 22 are dimensioned in such a way that a motion of the sealing element 02 relative to the sealing frame 03 can be realized up to a maximum stroke, particularly due to a compression of the compression element 17, and the sealing element 02 furthermore is secured relative to the sealing frame 03. This particularly means that the caulking 21 and the blind holes 22 of the sliding surface 01 cooperate in the longitudinal region 24 of the sliding surface 01, which is illustrated in an exemplary manner in FIG. 3, in such a way that a displacement of the sealing element 02 in the sealing frame 03 along the longitudinal direction of the groove 18 of the sealing frame 03 is prevented. As already mentioned above, the caulkings may accordingly be realized in a punctiform manner or lead to corresponding circular projections or elevations on a lateral face of the groove 18, wherein the blind hole 22 is realized, for example, in the form of an oblong hole such that the caulking prevents a motion or a displacement of the sealing element 02 along the longitudinal direction of the groove 18 whereas the caulking 21 allows a motion of the sealing element in the pressing direction, i.e. perpendicular to the groove base 19 of the groove 18.

The corresponding design of a blind hole 22, as well as of the caulking 21 in the sidewall 20 of the sealing frame 03, is likewise illustrated in the sectional representation according to FIG. 5b, which shows a section along the plane AA in FIG. 5a.

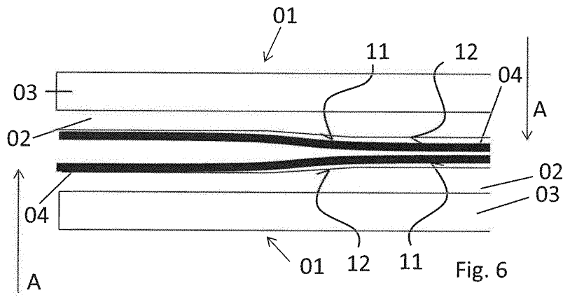

A pressing and sealing situation, which is schematically illustrated in an exemplary manner in the detail according to FIG. 6, is produced by the inventive compression element 17 for the flexibilization of the sealing element of the sliding surface, particularly in the entry and exit regions of the double-belt press, i.e. in the regions, in which the materials 05 to be pressed together extend and are guided perpendicular to the direction of rotation of the double-belt press. For example, the detail of the sectional representation according to FIG. 6 may likewise be extracted from the region II. in FIG. 3 and extend along the axis B. Analogous to FIG. 1, this figure shows the two press belts 04 of the double-belt press, as well as the sliding surface 01 that abut on or are pressed against the inner side 11 of the press belts 04. In the example according to FIG. 6, undersized materials 05 to be pressed together are also introduced into the double-belt press such that the materials 05 to be pressed together do not extend over the full width of the press belts 04, but rather end, in particular, within the width of the reaction zone 13 formed by the longitudinal sections of the sliding surface 01 and their distance from one another. However, a flexibilization of the sealing element 02 is achieved because the compression element 17, which is not illustrated in the sectional representation according to FIG. 6, is arranged between the respective sealing element 02 of the sliding surface 01 and the sealing frame 03 of the sliding surface 01 and allows a motion of the sealing element 02 relative to the sealing frame 03, wherein this flexibilization in turn leads to the sealing element 02 being able to better adapt itself to the progression of the press belt 04 as a result of the contact pressure exerted upon the sliding surface 01 in the pressing direction A or, vice versa, the contact pressures of the sealing surfaces 12 upon the inner side 11 of the press belts 04 being able to better reproduce the uneven surface or the uneven progression of the press belts, particularly the inner side 11 of the press belts 04, in connection with the not-shown compression elements 17 and at the same time to exert a more homogenous pressure upon the inner side 11 of the press belts 04. According to a comparison between FIG. 6 and FIG. 1, the variable adaptation of the sealing element 02 to the progression of the press belt 04 therefore prevents the formation of the leakage gap 06 shown in FIG. 1 such that the double-belt press can on the one hand be operated with undersized materials to be pressed together and the sliding surface 01 on the other hand exert a uniform contact pressure upon the inner side 11 of the press belts 04. The relative motion, as well as the sectional or local option of a motion of the sealing element 02 relative to the sealing frame 03 realized by providing the compression element 17, is also clearly visible or illustrated in FIG. 6 because the sealing element 02 protrudes from the sealing frame 03 over the width of the illustration in FIG. 6 to different extents in different regions of the entry the region of the belt press, wherein this is once again realized or made possible by a local or locally different compression of the compression element 17.

### LIST OF REFERENCE SYMBOLS

01 Sliding surface

02 Sealing element

03 Sealing frame

04 Press belt

05 Materials to be pressed together

06 Leakage gap

07 Base element

08 Pressure chamber

09 Vacuum chamber

10 Pressing element

11 Inner side

12 Sealing surface

13 Reaction zone

14 Entry region

15 Exit region

16 Recess

17 Compression element

18 Groove

19 Groove base

20 Sidewall

21 Caulking

22 Blind hole

23 Lateral face

1. A sliding surface for a continuously operating double-belt press for manufacturing endless material strips, wherein the double-belt press comprises an upper and a lower endless press belt (04) that are guided over deflection rollers, wherein a reaction zone (13), in which the material strip is guided and pressed together under a surface pressure, is formed between the opposing outer sides of the press belts, wherein the double-belt press furthermore has a pressure chamber (08) that generates at least part of the surface pressure and is formed in the reaction zone (13) between a base element (07), and an inner side (11) of the press belt (04), wherein said pressure chamber can be pressurised with a fluidic pressure medium and is laterally bounded and sealed by the at least one annular, closed sliding surface (01), wherein the sliding surface (01) has a sealing surface (12) for abutting on the inner side (11) of the press belt (04) in a sealing manner, and wherein the sliding surface (01) comprises a sealing element (02) that forms the sealing surface (12) and a sealing frame (03) that at least partially accommodates the sealing element (02) and serves for movably supporting the sliding surface (01) in the base element (07), wherein a compression element (17) is arranged between the sealing frame (03) and the sealing element (02) at least in a pressing direction, wherein said compression element allows a motion of the sealing element (02) relative to the sealing frame (03) due to an elastic compression, especially in reaction to a pressure application on the sliding surface (01) in the pressing direction.

2. The sliding surface according to claim 1, wherein the compression element (17) is realized in the form of a closed O-ring or in the form of an inserted, open sealing cord with circular cross section.

3. The sliding surface according to claim 1, wherein the sealing frame (03) comprises a groove (18) for accommodating the sealing element, wherein the compression element (17) is arranged along a groove base (19) of the groove (18).

4. The sliding surface according to claim 1, wherein the sealing element (02) is at least sectionally made of a material with a low modulus of elasticity, particularly a polymer or a metal.

5. The sliding surface according to claim 1, wherein the sealing element at least sectionally comprises blind holes (22) or milled recesses on a lateral face (23) bordering on the sealing surface (12), wherein the sealing frame (03) comprises caulkings (21) that at least partially engage into the blind holes and secure the sealing element relative to the sealing frame (03).

6. The sliding surface according to claim 5, wherein the blind holes and the caulking (21) are dimensioned relative to one another in such a way that the motion of the sealing element relative to the sealing frame (03) can be realized up to a maximum stroke due to a compression of the compression element (17) and the sealing element (02) furthermore is secured relative to the sealing frame (03).

7. A continuously operating double-belt press for manufacturing endless material strips, wherein the double-belt press comprises a rigid press frame, deflection rollers that are rotatably supported on bearing brackets of the press frame and an upper and a lower endless press belt (04) that are guided over the deflection rollers, wherein a reaction zone (13), in which the material strip is guided and pressed together under a surface pressure, is formed between the opposing outer sides of the press belts, wherein the double-belt press furthermore has a pressure chamber (08) that generates at least part of the surface pressure and is formed in the region of the reaction zone (13) between a base element (07), and an inner side (11) of the press belt (04), wherein said pressure chamber can be acted upon with a fluidic pressure medium and is laterally bounded by the at least one annular, closed sliding surface (01), wherein the sliding surface (01) has a sealing surface (12) for abutting on the inner side (11) of the press belt (04) in a sealing manner and is supported in the base element (07) so as to be movable in a pressing direction, and wherein the support comprises an at least partially elastic, movable pressing element (10) that presses the sealing surface (12) against the inner side (11) of the press belt (04) in the pressing direction due to a pressure application on the sliding surface (01) on the side of the base element, and further comprising a sliding surface (01) according to claim 1.

8. The double-belt press according to claim 7, further comprising two annular, closed sliding surfaces (01) according to claim 1, which at least sectionally extend parallel to one another.

9. The sliding surface according to claim 1, wherein the endless material strips are laminates.

10. The sliding surface according to claim 1, wherein the laminates are copper laminate, decorative laminate, fiber-reinforced plastic laminate and/or other technical laminates.

11. The sliding surface according to claim 1, wherein the base element (07) is a heating plate.

12. The double-belt press according to claim 7, wherein the endless material strips are laminates.

13. The double-belt press according to claim 12, wherein the laminates are copper laminate, decorative laminate, fiber-reinforced plastic laminates and/or other technical laminates.

14. The double-belt press according to claim 7, wherein the base element (07) is a heating plate.

15. The double-belt press according to claim 7, wherein said pressure chamber is sealed by the at least one annular, closed sliding surface (01).
